(19) United States
(12) Patent Application Publication
(10) Pub. No.: US 2015/0281928 A1
(43) Pub. Date: Oct. 1, 2015

(54) SYSTEM AND METHOD FOR FLEXIBLY SENDING COMMERCIAL MOBILE ALERT SYSTEM MESSAGES (CMAS) AND EARTHQUAKE AND TSUNAMI WARNING SYSTEM (EWTS) ALERT MESSAGES

(71) Applicant: WEST CORPORATION, OMAHA, NE (US)

(72) Inventor: Timothy L. Auen, Thornton, CO (US)

(73) Assignee: WEST CORPORATION, OMAHA, NE (US)

(21) Appl. No.: 14/231,954

(22) Filed: Apr. 1, 2014

(51) Int. Cl. H04W 4/22; H04L 12/58; H04W 4/18; H04W 4/02; H04W 4/12; H04W 4/14

(52) U.S. Cl. CPC H04W 4/22; H04W 4/12; H04W 4/14; H04W 4/18; H04W 4/02; H04L 51/20

(57) ABSTRACT

A system and method for sending Commercial Mobile Alert System (CMAS) and Earthquake and Tsunami Warning System (ETWS) alert messages to recipients who are not located within the designated alert area. Recipients specify filter criteria to define geographic areas of interest and the types of alerts of interest by matching Extensible Markup Language (XML) tags and data contained in the alert message. Alert messages may be sent to the recipient via SMS, e-mail, phone or push notification service.

### FIELD OF THE INVENTION

The present invention is directed to sending Commercial Mobile Alert System (CMAS) and Earthquake and Tsunami Warning System (ETWS) alert messages to recipients who are located outside of a designated alert area.

### BACKGROUND OF THE INVENTION

CMAS was initiated as part of the Security and Accountability For Every Port Act of 2006 (SAFE Port Act), the Warning Alert and Response Network (WARN) Act, which was passed by Congress in September 2006 and was signed into law by President George W. Bush on Oct. 13, 2006. The FCC released the “First Report and Order” for CMAS on Apr. 9, 2008. This First Report and Order adopted an architecture and a set of rules for transmitting emergency alerts by Commercial Mobile Service (CMS) providers. By way of example and not by way of limitation, CMS providers within the United States include Verizon, AT&T, Sprint and T-Mobile.

The First Report and Order architecture concluded that a Federal Government entity should aggregate, authenticate, and transmit alerts over a standard interface to the CMS providers.

The First Report and Order also included rules for emergency alert formatting, classes, and elements. Specifically, participating CMS providers transmit three classes of alerts: Presidential, Imminent Threat, and AMBER alerts. In addition, CMS providers are required to geographically target alerts, support accessibility for people with disabilities and the elderly by including an audio attention signal and vibration cadence on CMAS-capable handsets, and support subscribers who have roamed upon a CMS provider's network and the subscriber's mobile device is configured for and technically capable of receiving alert messages from the roamed upon network.

The FCC released the “Second Report and Order” for CMAS on Jul. 8, 2008. This Second Report and Order defined a Subscriber Alert Opt-Out feature which refers to the ability of a subscriber to configure his/her mobile device to not alert and present the receipt of a CMAS Alert message for which the subscriber has chosen to opt-out of receiving. With the exception of Presidential messages, which are always transmitted, the opt-out feature allows the choice to opt out of Imminent Threat Alert messages and Child Abduction Emergency/AMBER Alert messages.

ETWS satisfies the requirements concerning the distribution of emergency information on earthquakes, tsunamis and other natural disasters and is based on NTT DOCOMO's Area Mail service in Japan. The Area Mail service began distributing earthquake warning messages to mobile terminals in 2007 to address the common occurrence of earthquakes in Japan. Although ETWS originated independently from CMAS, the technical realization of sending ETWS alert messages is identical to sending CMAS alert messages.

Common to CMAS and ETWS is the use of Cell Broadcast Service (CBS) for the delivery of alert messages from a CMS provider to a mobile handset. CBS, CMAS and ETWS specify the distribution area three different ways: (1) in CBS, the distribution area is specified in cell units, (2) in CMAS, the distribution area is specified by a geographic area that can be a combination of text description, polygon, circle, geocode and altitude/ceiling, and (3) in ETWS, the distribution area is specified with three levels of granularities: cell units, tracking area identifiers and emergency area identifiers.

A problem in the art is that CMAS and ETWS emergency alerts are only distributed to recipients within the designated geographic region. For example, a person living in New York cannot receive an alert when a tornado affects his/her elderly parents' hometown in Kansas.

More importantly, if a mobile phone user travels to a geographic area away from his/her home, then he/she will no longer receive alert notifications regarding his/her home location. Indeed, there are many scenarios where a person in one geographic area wants to know about an emergency alert in a different geographic area.

There is a need for a system and method for flexibly sending alert messages to recipients who are not located within the designated alert area.

### SUMMARY OF THE INVENTION

In accordance with one aspect of this invention, disclosed is a method for sending Commercial Mobile Alert System (CMAS) and Earthquake and Tsunami Warning System (ETWS) alert messages to recipients who are not located within a geographic area designated to receive the alert. The method includes: (a) receiving a request for sending an alert message wherein the request comprises a filter criteria, a notification method and a delivery address; (b) receiving an alert message; (c) determining the designated alert area in the received alert message; (d) applying the filter criteria from the received request to the received alert message to determine if the alert message should be sent to the recipient; (e) converting the received alert messages into a format compatible with the notification method; and (f) sending the converted alert message to the recipient based on the notification method and delivery address.

In accordance with another aspect of this invention, disclosed is a system for sending Commercial Mobile Alert System (CMAS) and Earthquake and Tsunami Warning System (ETWS) alert messages to recipients who are not located within a geographic area designated to receive the alert. The system includes memory comprising instructions and a processor in communication with the memory wherein the processor, when executing the instructions, receives a request for sending an alert message wherein the request comprises a filter criteria, a notification method and a delivery address. Further, the processor, when executing the instructions, receives an alert message; determines the designated alert area in the received alert message; applies filter criteria from the received request to the received alert message to determine if the alert message should be sent to the recipient; converts the received alert messages into a format compatible with the notification method; and sends the converted alert message to the recipient based on the notification method and delivery address.

### BRIEF DESCRIPTION OF THE DRAWINGS

FIG. 1 is a schematic illustration of the CMAS Reference Architecture and provides context for the present invention;

FIG. 2 is a block diagram of an example processor for effecting the present invention;

FIG. 3 is a schematic diagram illustrating the method of the present invention;

FIG. 4 is a schematic diagram illustrating a user interface for receiving a request for sending alert messages;

FIG. 5 is a schematic diagram illustrating the system of the present invention; and

FIG. 6 is a schematic diagram illustrating the steps for converting an alert message into the appropriate format as requested by a recipient.

### DETAILED DESCRIPTION

In the following detailed description, numerous specific details are set forth in order to provide a thorough understanding of the present invention. However, those skilled in the art will understand that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

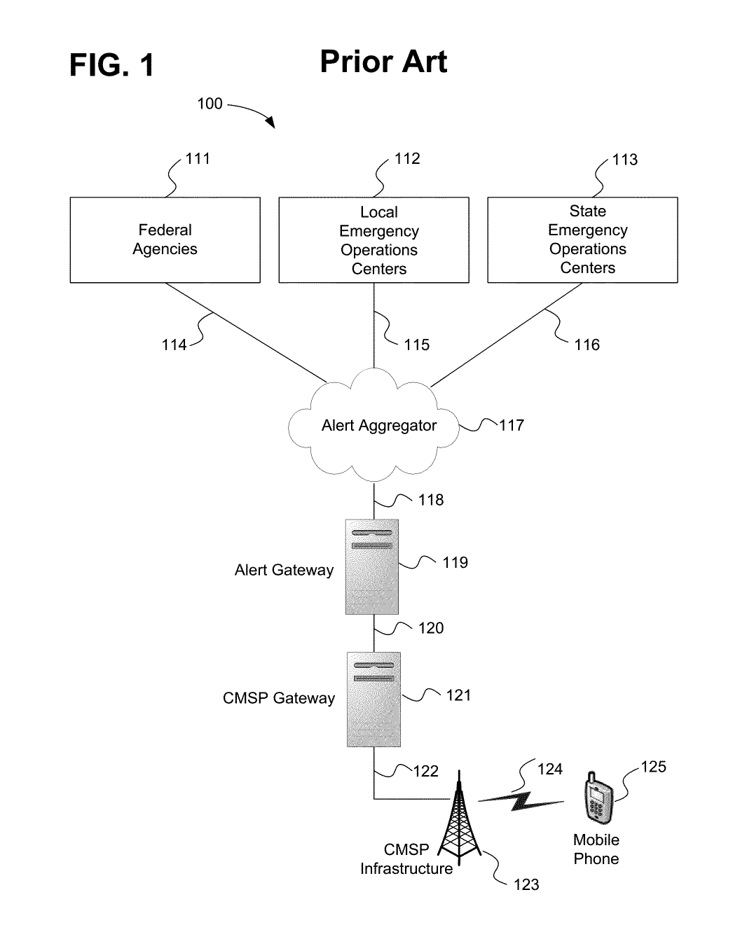

FIG. 1 is a schematic illustration of the prior art CMAS Reference Architecture 100 and provides context for this exemplary embodiment of this invention. In FIG. 1, government agencies 111-113 monitor for one or more emergency conditions. When an emergency condition is initially detected, or when status for a previously detected emergency condition is updated, government agencies 111-113 submit an alert message to the coupled national Alert Aggregator 117 over interfaces 114-116. The alert message structure comprises Extensible Markup Language (XML) tags and data, as known in the art and thus not described further. The Alert Aggregator 117 distributes alert messages to CMS providers using Alert Gateway 119 via interface 118. Alert Gateway 119 is coupled to CMS providers via CMSP Gateway 121 via interface 120.

Alert Gateway 119 sends alert messages to CMSP Gateway 121 across interface 120, which are formatted according to the Common Alerting Protocol (CAP) as defined by the Organization for the Advancement of Structured Information Standards (OASIS) in CAP-V1.1, dated October 2005, which is incorporated herein by reference in its entirety. The CMSP Gateway 120 receives alert messages and forwards them to a CMSP Infrastructure 123 for alert message processing. Processing within the CMSP Infrastructure 123 includes mapping a designated alert area in an alert message into cell units so that the alert message is directed to the appropriate cell sites and delivered using Cell Broadcast Service (CBS). Alert messages are then received by mobile phone 125 over wireless interface 124.

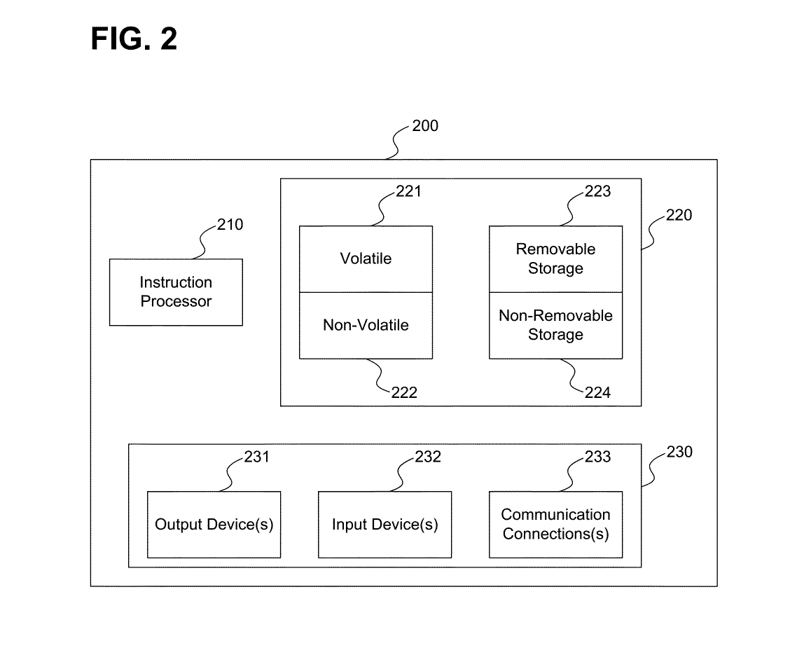

FIG. 2 is a block diagram of an example processor 200 in accordance with this embodiment of this invention. It is emphasized that the block diagram depicted in FIG. 2 is exemplary and not intended to imply a specific implementation. Thus, the processor 200 can be implemented in a single processor or multiple processors. Multiple processors can be distributed or centrally located. Multiple processors can communicate wirelessly, via hard wire, or any combination thereof.

Processor 200 comprises an instruction processor 210, a memory 220, and an input/output 230. The instruction processor unit 210, memory 220, and input/output 230 are coupled together (coupling not shown in FIG. 2) to allow communication among them. The input/output 230 is capable of providing and/or receiving components, commands, and/or instructions, utilized to, for example, receive requests from recipients, receive alert messages and send alert messages.

The processor 200 is preferably implemented as a client processor and/or a server processor. In this exemplary basic configuration, the processor 200 includes at least one instruction processor 210 and memory 220. The memory 220 stores any information utilized in conjunction with transmitting, receiving, and/or processing recipient requests, alert messages, telephonic communications, data communications, etc. For example, as described above, the memory is capable of storing processing instructions for processing alert messages and recipient requests. Depending upon the configuration and type of processor, the memory 220 can be volatile (such as RAM) 221, non-volatile (such as ROM, flash memory, etc.) 222, or a combination thereof. The processor 200 can have additional features/functionality. For example, the processor 200 can include additional storage (removable storage 223 and/or non-removable storage 224) including, but not limited to, magnetic or optical disks, tape, flash, smart cards or a combination thereof. Computer storage media, such as memory and storage elements 220, 221, 222, 223, and 224, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 200. Any such computer storage media may be part of the processor 200.

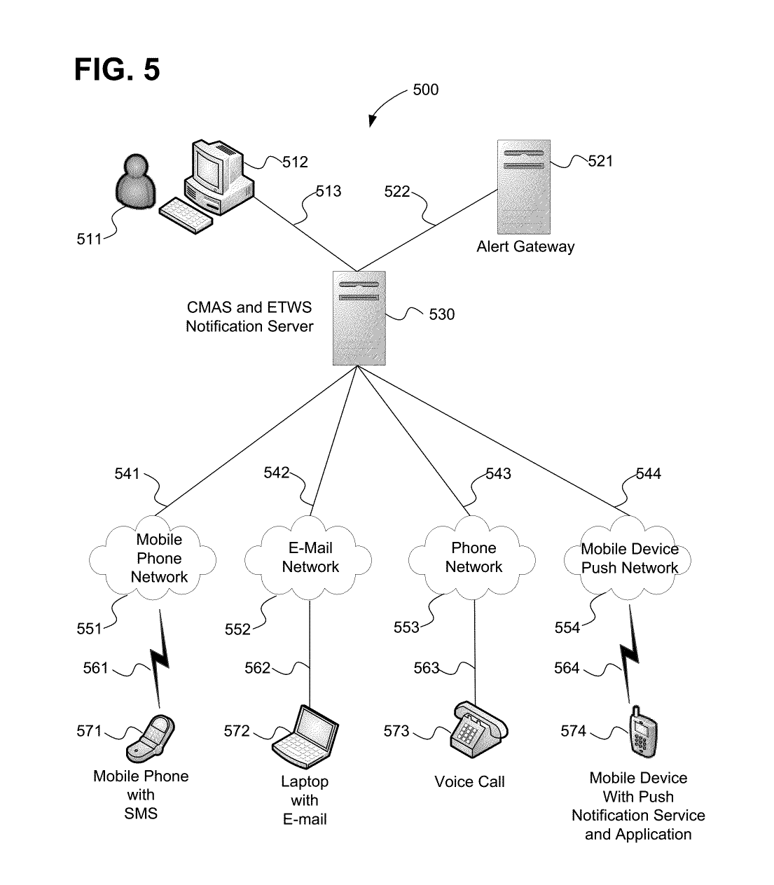

The processor 200 includes the communications connection(s) 233 that allow the processor 200 to communicate with other devices, for example with Alert Gateway 119 via interface 120 as illustrated in FIG. 1 or with Alert Gateway 521 via interface 522 as illustrated in FIG. 5. Communications connection(s) 233 is an example of communication media. Communication media typically embody computer-readable instructions, data structures, program modules or other data in a modulated data signal such as a carrier wave or other transport mechanism and includes any information delivery media. For purposes of this patent specification, the term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer-readable media as used herein includes both storage media and communication media. The processor 200 also can have input device(s) 232 such as keyboard, keypad, mouse, pen, voice input device, touch input device, etc. Output device(s) 231 such as a display, speakers, printer, etc. also can be included.

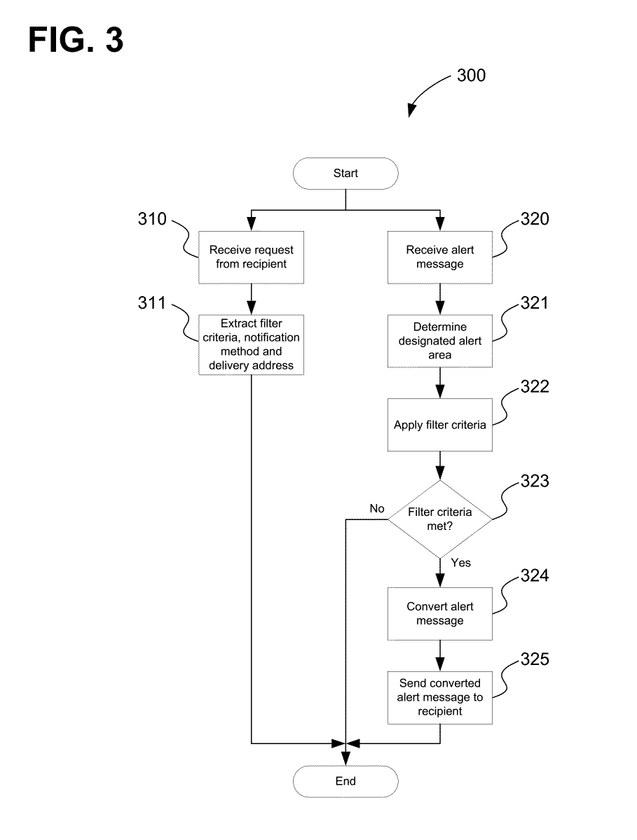

FIG. 3 illustrates an exemplary method 300 for effecting the present invention. The method comprises two processing flows. One flow receives and processes alert requests from recipients and is depicted in blocks 310-311. The second flow receives and processes alert messages and is depicted in blocks 320-325.

At block 310, a request is received from a recipient interested in being sent alert messages designated for a location different his/her current location.

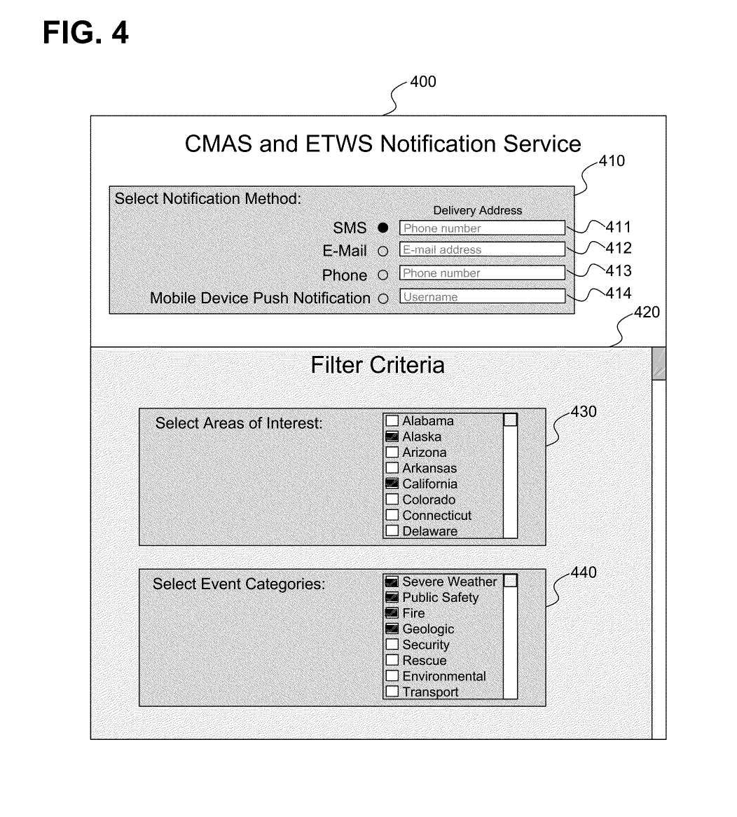

Turning now to FIG. 4, block 400 illustrates one exemplary embodiment for receiving a request using a web interface accessible from the Internet where the web interface allows a recipient to enter a notification method, a delivery address and filter criteria. In block 410, the recipient enters a method for sending the alert message that includes four options: (1) delivery via SMS where the recipient enters a phone number as depicted in 411, (2) delivery via e-mail where the recipient enters an e-mail address as depicted in 412, (3) delivery via a voice phone call where the recipient enters a phone number as depicted in 413 and, (4) delivery to a mobile device via a push notification service where the recipient enters a username as depicted in 414.

The set of notification methods that may be used include at least one member of a group consisting of: SMS, e-mail, phone, mobile device push notification, pager, social networking and multi-media messaging (MMS). The means for delivering an alert message via these notification methods is known to one skilled in the art. All such notification methods and means are contemplated as within the scope of the present disclosure.

In block 420 the recipient enters filter criteria. As depicted in blocks 430 and 440, filter criteria includes a geographic area of interest and types of events. As those skilled in the art will appreciate, additional filter criteria based on matching Extensible Markup Language (XML) tags and data in the alert message may be used and all such means and methods are contemplated as within the scope of the present disclosure.

Returning now to FIG. 3, at block 311 the method for processing alert requests from recipients continues by extracting the filter criteria, notification method and delivery address parameters. The filter criteria is used to match a received alert message in block 322 and the notification method and delivery address parameters are used to send the received alert message to the recipient in block 325.

At block 320, alert messages are received from Alert Gateway 119 via interface 120 as illustrated in FIG. 1 or alert messages are received from Alert Gateway 521 via interface 522 as illustrated in FIG. 5. Each alert message designates at least one alert area. The designated alert area in the alert message is used by CMS providers to determine which cell sites need to broadcast the alert message using Cell Broadcast Service. In the present invention, the designated alert area is extracted from the alert message in block 321 and is compared with the filter criteria in block 322, with filter criteria provided in a recipient request, as shown in blocks 310-311.

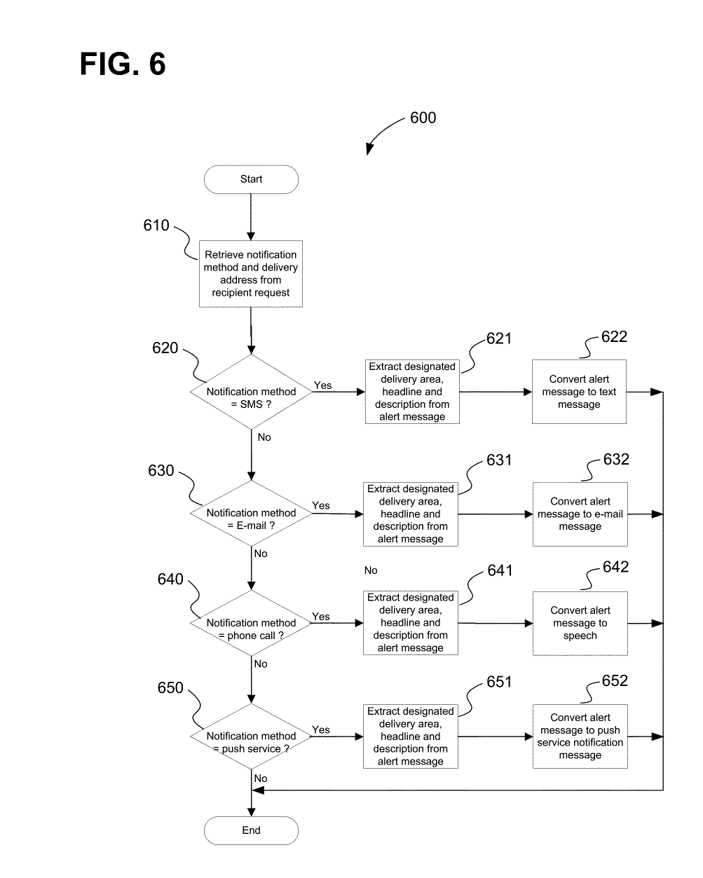

After applying the filter criteria in block 322, block 323 determines if the filter criteria are met. If the filter criteria are not met, then the method ends and the alert message is not sent to the recipient. If the filter criteria are met, the method continues to block 324 where the received alert message is converted to a format compatible with the notification method. FIG. 6, flowchart 600 illustrates the steps for converting an alert message into the appropriate format.

Turning to FIG. 6, block 610 retrieves the notification method and delivery address provided by the recipient. The retrieved notification method is used in blocks 620, 630, 640 and 650 to identify the appropriate format. If the notification method is SMS, block 621 extracts the designated delivery area, headline and description from the alert message and block 622 converts the extracted data to short message format. If the notification method is e-mail, block 631 extracts the designated delivery area, headline and description from the alert message and block 632 converts the extracted data to e-mail format. If the notification method is a voice phone call, block 641 extracts the designated delivery area, headline and description from the alert message and block 622 applies text-to-speech conversion on the information extracted. As those skilled in the art will appreciate, alternative information may be extracted from the alert message and sent to the recipient. All such means and methods are contemplated as within the scope of the present disclosure.

Returning now to FIG. 3, at block 325 the method continues by sending the converted alert message to the recipient using the method provided by the recipient in block 410 and delivery address provided in blocks 411-414. It should be understood by one skilled in the art that the delivery methods for sending short messages, e-mails, push notifications and originating voice calls are known.

FIG. 5 illustrates an exemplary system 500 of the present invention. Recipient 511 inputs a request to be sent alert messages designated for a location different from his/her current location into a web browser on a personal computer 512. FIG. 4 400 is a schematic diagram illustrating the web user interface. Personal computer 512 is coupled to a web server on the CMAS and ETWS Notification Server 530 via an Internet connection 513. The request includes filter criteria, notification method and delivery address parameters. The filter criteria is used to match a received alert message and the notification method and delivery address parameters are used to send the received alert message to the recipient.

Alert messages are sent from Alert Gateway 521 to the CMAS and ETWS Notification Server 530 across interface 522 and are formatted using the Common Alerting Protocol (CAP) as defined by the Organization for the Advancement of Structured Information Standards (OASIS) in CAP-V1.1, dated October 2005 incorporated herein by reference.

In this exemplary embodiment, the processor 200 depicted in FIG. 2 is contained in the CMAS and ETWS Notification Server 530 and supports the method 300 depicted in FIG. 3. In FIG. 3 block 325, an alert message is sent to the recipient. The CMAS and ETWS Notification Server 530 sends the alert message based on the notification method and delivery address provided by the recipient, as follows:
If delivery is via SMS, the CMAS and ETWS Notification Server 530 extracts information in the alert message to include the designated delivery area, headline and description, converts the extracted information to a text message and sends the message across interface 541 so that it received by the recipient's mobile phone 571 through mobile phone network 551 over the wireless interface 561.
If delivery is via e-mail, the CMAS and ETWS Notification Server 530 extracts information in the alert message to include the designated delivery area, headline and description, converts the extracted information to an e-mail message and sends the message across interface 542 so that it received by the recipient's laptop 572 through e-mail network 552 over interface 562.
If delivery is via a voice phone call, the CMAS and ETWS Notification Server 530 extracts information in the alert message to include the designated delivery area, headline and description, and applies text-to-speech conversion on the extracted information. The CMAS and ETWS Notification Server 530 then makes an outbound voice call over interface 543 to the phone number associated with phone 573. Phone 573 is connected to phone network 553 via interface 563.
If delivery is to a mobile device via a push notification service, the CMAS and ETWS Notification Server 530 extracts information in the alert message to include the designated delivery area, headline and description, converts the extracted information to a push notification message and sends the message across interface 544 to the recipient's username so that it received by an application in the recipient's mobile device 574 through push network 554 over wireless interface 564.

As those skilled in the art will appreciate, alternative information may be extracted from the alert message and sent to the recipient. All such means and methods are contemplated as within the scope of the present disclosure.

One exemplary embodiment for an alert message related to a severe thunderstorm warning is as follows:

```
<?xml version = “1.0” encoding = “UTF-8”?>
<alert xmlns = “urn:oasis:names:tc:emergency:cap:1.1”>
    <identifier>KSTO1055887203</identifier>
    <sender>KSTO@NWS.NOAA.GOV</sender>
    <sent>2003-06-17T14:57:00-07:00</sent>
    <status>Actual</status>
    <msgType>Alert</msgType>
    <scope>Public</scope>
    <info>
        <category>Met</category>
        <event>SEVERE THUNDERSTORM</event>
        <responseType>Shelter</responseType>
        <urgency>Immediate</urgency>
        <severity>Severe</severity>
        <certainty>Observed</certainty>
        <eventCode>
            <valueName>same</valueName>
            <value>SVR</value>
        </eventCode>
        <expires>2003-06-17T16:00:00-07:00</expires>
        <senderName>NATIONAL WEATHER SERVICE SACRAMENTO CA</senderName>
        <headline>SEVERE THUNDERSTORM WARNING</headline>
        <description> AT 254 PM PDT...NATIONAL WEATHER SERVICE DOPPLER RADAR
            INDICATED A SEVERE THUNDERSTORM OVER SOUTH CENTRAL ALPINE
            COUNTY...OR ABOUT 18 MILES SOUTHEAST OF KIRK WOOD...MOVING
            SOUTHWEST AT 5 MPH. HAIL...INTENSE RAIN AND STRONG DAMAGING
            WINDS ARE LIKELY WITH THIS STORM.</description>
        <instruction>TAKE COVER IN A SUBSTANTIAL SHELTER UNTIL THE STORM
            PASSES.</instruction>
        <contact>BARUFFALDI/JUSKIE</contact>
        <area>
            <areaDesc>EXTREME NORTH CENTRAL TUOLUMNE COUNTY IN
                CALIFORNIA, EXTREME NORTHEASTERN 518 CALAVERAS COUNTY
                IN CALIFORNIA, SOUTHWESTERN ALPINE COUNTY IN
                CALIFORNIA</areaDesc>
            <polygon>38.47,−120.14 38.34,−119.95 38.52,−119.74 38.62,−119.89 38.47,
                −120.14</polygon>
            <geocode>
                <valueName>FIPS6</valueName>
                    <value>006109</value>
            </geocode>
            <geocode>
                <valueName>FIPS6</valueName>
                <value>006009</value>
            </geocode>
            <geocode>
                    <valueName>FIPS6</valueName
                <value>006003</value>
            </geocode>
        </area>
    </info>
</alert>
```

One exemplary embodiment for an alert message related to an earthquake report is as follows:

```
<?xml version = “1.0” encoding = “UTF-8”?>
<alert xmlns = “urn:oasis:names:tc:emergency:cap:1.1”>
    <identifier>TRI13970876.1</identifier>
    <sender>trinet@caltech.edu</sender>
<sent>2003-06-11T20:56:00-07:00</sent>
<status>Actual</status>
<msgType>Alert</msgType>
<scope>Public</scope>
<incidents>13970876</incidents>
<info>
    <category>Geo</category>
    <event>Earthquake</event>
    <urgency>Past</urgency>
    <severity>Minor</severity>
    <certainty>Observed</certainty>
    <senderName>Southern California Seismic Network (TriNet) operated by Caltech and
        USGS</senderName>
    <headline>EQ 3.4 Imperial County CA - PRELIMINARY REPORT</headline>
    <description>A minor earthquake measuring 3.4 on the Richter scale occurred near
        Brawley, California at 8:53 PM Pacific Daylight Time on Wednesday, June 11, 2003.
        (This is a computer-generated solution and has not yet been reviewed by a
        human.)</description>
    <web>http://www.trinet.org/scsn/scsn.html</web>
    <parameter>
        <valueName>EventID</valueName>
        <value>13970876</value>
    </parameter>
    <parameter>
        <valueName>Version</valueName>
        <value>1</value>
    </parameter>
    <parameter>
        <valueName>Magnitude</valueName>
        <value>3.4 MI</value>
    </parameter>
    <parameter>
        <valueName>Depth</valueName>
        <value>11.8 mi.</value>
        </parameter>
        <parameter>
            <valueName>Quality</valueName>
            <value>Excellent</value>
        </parameter>
            <area>
                <areaDesc>1 mi. WSW of Brawley, CA; 11 mi. N of E1 Centro, CA; 30 mi. E of
                    OCOTILLO (quarry); 1 mi. N of the Imperial Fault</areaDesc>
                <circle>32.9525,−115.5527 0</circle>
            </area>
    </info>
</alert>
```

As depicted in the previous two alert message embodiments above, CMAS alert messages are directed to a designated geographic area and contain standardized Extensible Markup Language (XML) tags and data that are used as filter criteria.

In the present invention, interested recipients receive alerts related to a geographic area that is different from their current location. In one embodiment, the designated geographic area is generated by an Alert Gateway communicatively connected to the CMAS. In other embodiments, the designated geographic area may be generated by any other device within or communicatively connected to the CMAS. The designated geographic area may be generated automatically, based on user input, or a combination of both.

In accordance with CMAS, a designated geographic area is described using several different representations. In one embodiment of a designated geographic area, the area is represented as a sequence of five characters. Such characters are letters or numbers, or a combination of both. Such characters are represented in ASCII codes, binary representations, or any other form or representation that allows such a code to be identified and read by computing devices. The first two characters or digits of designated geographic area identify the state or region of a geographical area. The last three characters or digits of the designated geographic area identify a specific county, region, or equivalent entities within the state or region identified by the first two characters or digits. Other quantities of characters or digits used to represent a geographical area, and other combinations of state, region, and geographical area identifiers are contemplated as within the scope of the present disclosure.

In another embodiment of a designated geographic area, the area is represented by a polygon with paired values of points defining coordinates of a polygon that delineates the affected area of the alert message.

In another embodiment of a geographic area, the area is represented by a circle with paired values representing the coordinates for the center point of the circle and a radius that delineates the affected area of the alert message.

By specifying a category for the filter criteria, interested recipients narrow the alerts received based on the following event categories:
Met (Severe Weather Warning)
Safety (Public Safety Warning)
Fire (Fire Warning)
Geo (Geologic Warning)
Security (Security Warning)
Rescue (Rescue Alert)
Health (Health Warning)
Env (Environmental Warning)
Transport (Transport Alert)
Infra (Infrastructure Warning)
CBRNE (Chemical, Biological, Radiological, Nuclear and high-yield Explosives Warning)
Other (Other Warning)

By specifying an event type for the filter criteria, interested recipients narrow the alerts received based on the following event types:
TOR (Tornado Warning)
VOW (Volcano Warning)
SVR (Severe Thunderstorm Warning)
EQW (Earthquake Warning)
TSW (Tsunami Warning)
BZW (Blizzard Warning)
DSW (Dust Storm Warning)
FFW (Flash Flood Warning)
HWW (High Wind Warning)
HUW (Hurricane Warning)
TRW (Tropical Storm Warning)
WSW (Winter Storm Warning)
CFW (Coastal Flood Warning)
FLW (Flood Warning)
FRW (Fire Warning)
SMW (Special Marine Warning)
AVW (Avalanche Warning)
CDW (Civil Danger Warning)
CEM (Civil Emergency)
HMW (HazMat Warning)
LEW (Police Warning)
CAE (AMBER Alert)
NUW (Nuclear Power Plant Warning)
RHW (Radiological Hazard)

By specifying timestamp information for the filter criteria, interested recipients narrow the alerts received based on a date/time range the alert message was sent.

While example embodiments of systems and methods for sending CMAS and ETWS alert messages to recipients who are not located within the designated alert area as described herein have been described in connection with various communications devices and computing devices/processors, the underlying concepts can be applied to any communications or computing device, processor, or system capable of receiving and processing notification requests and alert messages. The various techniques described herein can be implemented in connection with hardware or software or, where appropriate, with a combination of both. Thus, the methods and apparatuses for sending alert messages to recipients who are not located within the designated alert area, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for sending alert messages to recipients who are not located within the designated alert area. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and systems for sending CMAS and ETWS alert messages to recipients who are not located within the designated alert area as described herein can also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for sending alert messages to recipients who are not located within the designated alert area. When implemented on a general-purpose processor, the program code combines with the processor to provide a unique apparatus that operates to invoke the functionality of sending alert messages to recipients who are not located within the designated alert area. Additionally, any storage techniques used in connection with an alert message processing system can invariably be a combination of hardware and software.

While the systems and methods for sending CMAS and ETWS alert messages to recipients who are not located within the designated alert area have been described in connection with the various embodiments of the various figures, it is to be understood that other similar embodiments can be used or modifications and additions can be made to the described embodiments for performing the same functions of an alert message processing system without deviating from the described systems and methods. For example, one skilled in the art will recognize that an alert message processing system as described in the present application may apply to any environment, whether wired or wireless, and may be applied to any number of such devices connected via a communications network and interacting across the network. Therefore, an alert message processing system such as those described herein should not be limited to any single embodiment, but rather should be construed in breadth and scope in accordance with the appended claims.

1. A method for sending Commercial Mobile Alert System (CMAS) and Earthquake and Tsunami Warning System (ETWS) alert messages to recipients, wherein the recipients who are not located within a geographic area designated to receive the alert message; the method comprising:
(a) receiving a request for sending an alert message wherein the request comprises a filter criteria, a notification method and a delivery address;
(b) receiving an alert message;
(c) determining the designated alert area in the received alert message;
(d) applying the filter criteria from the received request to the received alert message to determine if the alert message should be sent to the recipient;
(e) converting the received alert messages into a format compatible with the notification method; and
(f) sending the converted alert message to the recipient based on the notification method and delivery address.

2. The method for sending an alert message as recited in claim 1 wherein the filter criteria specifies a geographic area.

3. The method for sending an alert message as recited in claim 1 wherein the received alert message comprises one of a plurality of event categories, and the filter criteria comprises one or more of said plurality of event categories.

4. The method for sending an alert message as recited in claim 1 wherein the received alert message comprises Extensible Markup Language (XML) tags and data, and the filter criteria comprises tags and data.

5. The method for sending an alert message as recited in claim 1 wherein the received alert message are formatted according to the Common Alerting Protocol (CAP).

6. The method for sending an alert message as recited in claim 1 wherein the notification method comprises Short Message Service (SMS) and the delivery address comprises a phone number, converting the received alert message to a short message and delivering the short message to the recipient via SMS.

7. The method for sending an alert message as recited in claim 1 wherein the notification method comprises e-mail and the delivery address comprises an e-mail address, converting the received alert message to an e-mail message and delivering the e-mail message to the recipient via e-mail.

8. The method for sending an alert message as recited in claim 1 wherein the notification method comprises phone and the delivery address comprises a phone number, converting the received alert message converted to speech, calling the phone number and delivering the speech.

9. The method for sending an alert message as recited in claim 1 wherein the notification method includes at least one member of a group consisting of: SMS, e-mail, phone, mobile device push notification, pager, social networking and multi-media messaging (MMS).

10. The method for sending an alert message as recited in claim 1 wherein the notification method comprises mobile device notification service and the delivery address comprises a username, converting the received alert message to a push notification message and sending the push notification message to a mobile device using a push notification service.

11. The method for sending an alert message as recited in claim 10 wherein an application in the mobile device receives the push notification message, the application compares the designated area in the push notification message to a current location of the mobile device, and if the application determines the current location to be within the designated area of the push notification message, the application in the mobile device suppresses presentation of the push notification message.

12. A system for sending Commercial Mobile Alert System (CMAS) and Earthquake and Tsunami Warning System (ETWS) alert messages to recipients, wherein the recipients who are not located within a geographic area designated to receive the alert message; the system comprising:
(a) memory comprising instructions; and
(b) a processor in communication with the memory, wherein the processor, when executing the instructions, performs operations comprising:
i. receiving a request for sending an alert message wherein the request comprises a filter criteria, a notification method and a delivery address;
ii. receiving an alert message;
iii. determining the designated alert area in the received alert message;
iv. applying the filter criteria from the received request to the received alert message to determine if the alert message should be sent to the recipient;
v. converting the received alert messages into a format compatible with the notification method; and
vi. sending the converted alert message to the recipient based on the notification method and delivery address.

13. The system for sending an alert message as recited in claim 12 wherein the filter criteria specifies a geographic area.

14. The system for sending an alert message as recited in claim 12 wherein the received alert message comprises one of a plurality of event categories, and the filter criteria comprises one or more of said plurality of event categories.

15. The system for sending an alert message as recited in claim 12 wherein the received alert message comprises Extensible Markup Language (XML) tags and data, and the filter criteria comprises tags and data.

16. The system for sending an alert message as recited in claim 12 wherein the received alert message are formatted according to the Common Alerting Protocol (CAP).

17. The system for sending an alert message as recited in claim 12 wherein the notification method comprises Short Message Service (SMS) and the delivery address comprises a phone number, converting the received alert message to a short message and delivering the short message to the recipient via SMS.

18. The system for sending an alert message as recited in claim 12 wherein the notification method comprises e-mail and the delivery address comprises an e-mail address, converting the received alert message to an e-mail message and delivering the e-mail message to the recipient via e-mail.

19. The system for sending an alert message as recited in claim 12 wherein the notification method comprises phone and the delivery address comprises a phone number, converting the received alert message converted to speech, calling the phone number and delivering the speech.

20. The system for sending an alert message as recited in claim 12 wherein the notification method includes at least one member of a group consisting of: SMS, e-mail, phone, mobile device push notification, pager, social networking and multi-media messaging (MMS).

21. The system for sending an alert message as recited in claim 12 wherein the notification method comprises mobile device notification service and the delivery address comprises a username, converting the received alert message to a push notification message and sending the push notification message to a mobile device using a push notification service.

22. The system for sending an alert message as recited in claim 21 wherein an application in the mobile device receives the push notification message, the application compares the designated area in the push notification message to a current location of the mobile device, and if the application determines the current location to be within the designated area of the push notification message, the application in the mobile device suppresses presentation of the push notification message.
